(19) United States
(12) Patent Application Publication
(10) Pub. No.: US 2012/0312848 A1
(43) Pub. Date: Dec. 13, 2012

(54) Advanced Composite Vehicle Article Carrier Component And Method Of Making Same

(75) Inventors: Arthur K. Delusky, Detroit, MI (US); R. Byron Pipes, Lafayette, IN (US); Mark R. Pipes, North Beach, MD (US); John R. Courter, Palmdale, CA (US); Gordon Michie, LaSalle (CA)

(73) Assignee: JAC PRODUCTS, INC., Saline, MI (US)

(21) Appl. No.: 13/475,271

(22) Filed: May 18, 2012

Related U.S. Application Data
(60) Provisional application No. 61/519,350, filed on May 20, 2011.

(51) Int. Cl. B60R 9/04; B29C 70/24

(52) U.S. Cl. 224/309; 156/149

(57) ABSTRACT

A vehicle article carrier component and a method of manufacturing the component are disclosed. The method may involve forming a braided, tubular cylindrical form including a plurality of fibers having at least one of a curvilinear pattern or a helical pattern. A reinforcing form of unidirectionally oriented fibers may be positioned at a predetermined location on one of an interior or exterior surface of the braided tubular cylindrical form, to thus create a composite assembly. A resin may be used to saturate the composite assembly. An inflatable bladder and a molding tool may be used to form a finished, unitary composite part through a molding operation.

### CROSS-REFERENCE TO RELATED APPLICATIONS

This claims the benefit of U.S. Provisional Application No. 61/519,350, filed on May 20, 2011. The entire disclosure of the above application is incorporated herein by reference.

### FIELD

The present disclosure relates to vehicle article carrier systems and components thereof, and more particularly to a vehicle article carrier system having one or more components formed from a carbon fiber composite material.

### BACKGROUND

The statements in this section merely provide background information related to the present disclosure and may not constitute prior art.

Vehicle article carriers are used in a wide variety of applications to support articles of various sizes and shapes above an outer body surface of a motor vehicle. Typically such vehicle article carriers include a pair of support rails that are secured to the outer body surface, and at least one cross bar that is positioned transversely between the support rails. The articles are supported on top of the cross bar and are typically held to the cross bar using bungee cords, nylon straps or other types of securing straps.

Presently there is strong interest in the automotive industry to reduce the weight of all vehicles. Manufacturers are looking at all possible ways to remove weight from vehicles in the interest of improving fuel economy for each vehicle. Governmental regulations are expected to place increasing pressure on automotive manufacturers to meet ever increasing fuel economy standards over the coming years. Thus, any means to reduce the weight of a vehicle without sacrificing available space within the vehicle, and the durability and crashworthiness of the vehicle, is expected to be of importance to vehicle manufacturers. As a consequence, any means to significantly reduce the overall weight of a vehicle article carrier system, without otherwise reducing its robustness, its durability or its functionality, will be considered as being of significant importance and value.

### SUMMARY

In one aspect the present disclosure relates to a method of manufacturing a vehicle article carrier component. The method may comprise forming a braided, tubular cylindrical form including a plurality of fibers having at least one of a curvilinear pattern or a helical pattern. The method may further comprise providing a reinforcing form of unidirectionally oriented fibers that is positioned at a predetermined location on the braided tubular cylindrical form to create a composite assembly, on one of an interior surface or an exterior surface of the braided tubular cylindrical form. A resin may be provided for saturating the composite assembly. This process can be achieved through several approaches that include resin transfer at pressures equal to or greater than atmospheric. An inflatable bladder may be inserted inside the composite assembly without upsetting positioning of the reinforcing form. The composite assembly may be positioned in a cavity of a molding tool, wherein the cavity is shaped and of dimensions to create the component final geometry. The inflatable bladder may be inflated to force an outer surface portion of the composite assembly against interior surfaces of the molding tool. The molding tool and/or the bladder inflating fluid may be heated to cause the composite assembly to be heated to a temperature sufficient to cause the resin to flow and fully saturate the carbon fibers of the braided, tubular cylindrical form and the fibers of the reinforcing form. The braided tubular cylindrical form may then be kept in the molding tool for a predetermined cooling time to allow it to cool or by cooling the assembly by cooling the inflating fluid. The composite assembly may then be removed from the molding tool, wherein the composite assembly will be shaped to form the vehicle article carrier component.

In another aspect the present disclosure relates to a method of manufacturing a vehicle article carrier component. The method may comprise forming a braided, tubular cylindrical form impregnated with a resin, the braided, tubular cylindrical form including a plurality of fibers having at least one of a curvilinear pattern or a helical pattern. The chosen pattern may include having the fibers extending at an angle of about 0 degrees to about +/−90 degrees relative to a longitudinal axis of the braided, tubular cylindrical form. A reinforcing form may be provided which is impregnated with a resin (prepreg). The reinforcing form may have unidirectionally oriented fibers and be positioned at a predetermined location on an inside surface of the braided tubular cylindrical form, to thus create a composite assembly. Longitudinal fibers (0 degrees) can be provided in textile or prepreg form through interstiching with fibers with elongation capacity. An inflatable bladder may be positioned within the composite assembly without upsetting positioning of the reinforcing form. The composite assembly may be positioned in a cavity of a molding tool, wherein the cavity is shaped and of dimensions to create the vehicle article carrier component. The inflatable bladder may then be inflated to force an outer surface portion of the composite assembly against interior surfaces of the cavity of the molding tool. The molding tool and/or the bladder inflating fluid may be heated to cause the composite assembly to be heated to a temperature sufficient to cause the resin to flow and fully saturate the fibers of the braided, tubular cylindrical form and the fibers of the reinforcing form. Then a predetermined time may be allowed to pass for the composite assembly to cool while it remains in the molding tool or by cooling the assembly through cooling the inflating fluid. The composite assembly may be removed from the molding tool, wherein the composite assembly will have been shaped to form the vehicle article carrier component.

In still another aspect the present disclosure relates to a molded, unitary vehicle article carrier component. The component may comprise a tubular central portion, a curving leading edge and a curving trailing edge. Each of the leading and trailing edges may form a support foot for positioning the central portion elevationally above an outer roof surface of a vehicle when the unitary vehicle article carrier component is secured to the outer roof surface. The tubular central portion and the curving leading edge and curving trailing edge portions may be integrally formed in a molding process from a braided, tubular cylindrical form including a plurality of fibers and a polymer resin.

### BRIEF DESCRIPTION OF THE DRAWINGS

The drawings described herein are for illustration purposes only and are not intended to limit the scope of the present disclosure in any way.

FIG. 1 is a perspective view of a vehicle incorporating a vehicle article carrier having a pair of carbon fiber support rails, in accordance with one embodiment of the present disclosure;

FIG. 2 is an enlarged perspective view of just the support rails of the present disclosure detached from the vehicle shown in FIG. 1;

FIG. 3 is a bottom perspective view of one support rail showing a leading end and central portion thereof; and

FIG. 4 is a cross section view through the one of the support rails showing a C-shaped metallic track insert molded therein to provide a means of adjustable attachment for an end support of one of the cross bars;

FIG. 5 is a cross sectional view through the central support portion illustrating another embodiment in which a metallic plate is insert molded within the support foot;

FIG. 6 is a flowchart illustrating another example of various manufacturing operations that may be performed to create a carbon fiber support rail in accordance with the present disclosure;

FIG. 7 is an elevational view of the cylindrical form with its helical carbon fibers, as well as the reinforcing form; and

FIG. 8 is a view of the bladder about to be inserted into the cylindrical form after the reinforcing form has been positioned on an interior surface of the cylindrical form.

### DETAILED DESCRIPTION

The following description is merely exemplary in nature and is not intended to limit the present disclosure, application, or uses. It should be understood that throughout the drawings, corresponding reference numerals indicate like or corresponding parts and features.

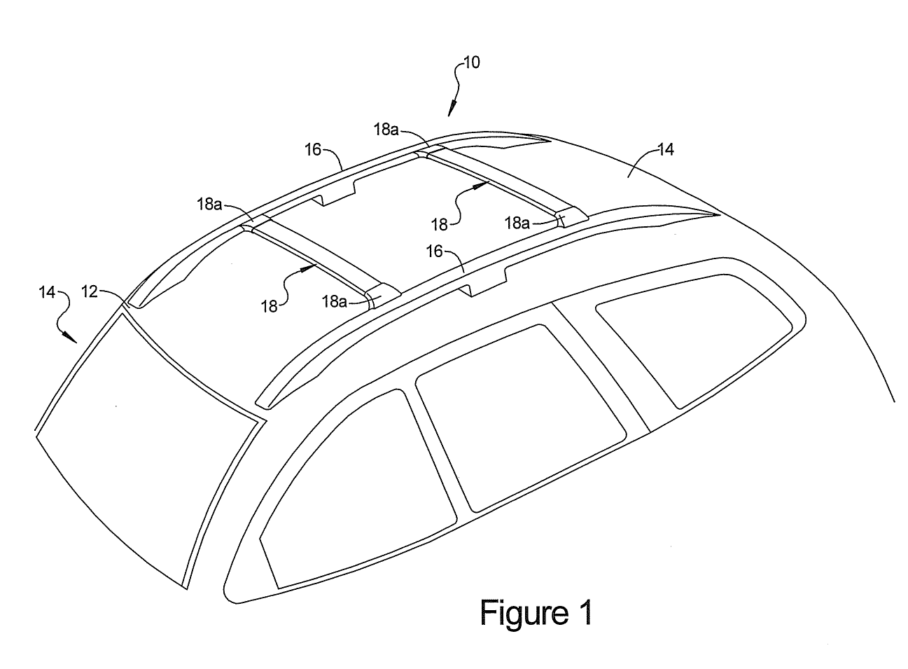

Referring to FIG. 1 there is shown a vehicle article carrier 10 disposed on an outer body surface 12 of a motor vehicle 14. While the motor vehicle 14 is shown as an SUV, it will be appreciated that the vehicle article carrier 10 is not limited to use with only SUVs, but is instead expected to find utility with a wide variety of vehicles such as, but not limited to, crossovers, sedans, minivans, light trucks, etc.

The vehicle article carrier 10 may include a pair of support rails 16 that are manufactured from composite materials, and in one form from carbon fiber. The support rails 16 are adapted to be fixedly secured to the outer body surface 12, preferably parallel to one another, along a major longitudinal length of the vehicle 14. The support rails 16 may be designed to rest in a roof ditch portion (not specifically shown in FIG. 1) of the outer body surface 12, so as to be substantially flush with an outer surface of the outer body surface 12, or adjacent to the roof ditch portion. One or more cross bars 18 each having a pair of end supports 18a may be formed as separate components and physically secured by suitable clamping structure to be easily attached and detached from the support rails 16. Other forms of attachment structure besides a clamping mechanism could be implemented as well to secure the cross bars thereto. In this example the cross bars 18 are shown as being identical in shape and construction, but they need not be identical.

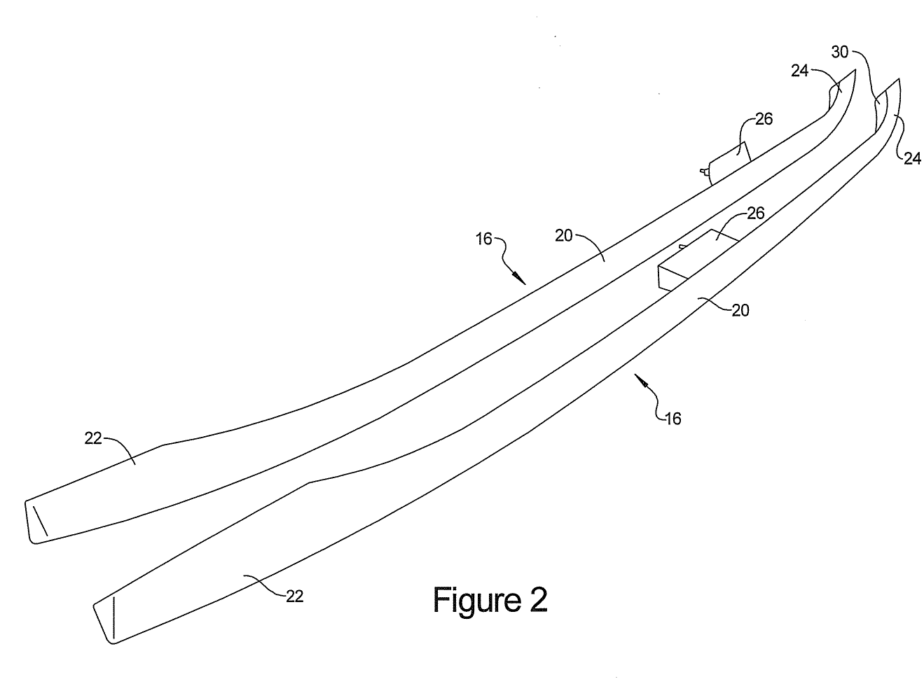

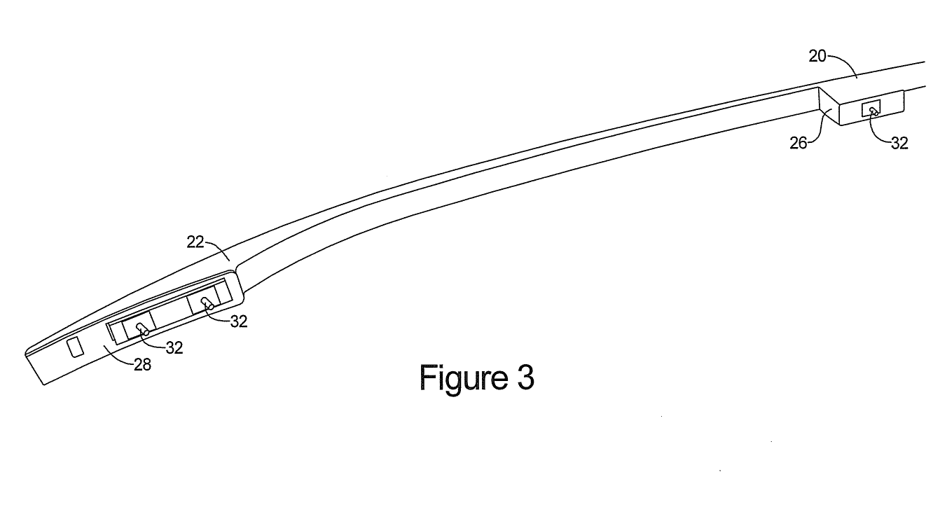

Referring to FIGS. 2-3, one of the support rails 16 can be seen in greater detail. The support rail 16 in this example forms a unitary component which is made from carbon fiber and has a tubular construction. The support rail 16 may be formed from a suitable molding or manufacturing process in which, in one example process, a one or a plurality of plies of carbon fiber are laid over, or wrapped over, a mandrel. Thermoset or thermoplastic polymer resin may be added to the carbon fiber either as a prepreg or in a secondary operation such as resin transfer molding (RTM). The mandrel (not shown) has an outer shape that closely approximates the desired outer shape of the support rail 16 when the layup is completed. The mandrel may be formed in one or two pieces to aid in facilitating removal thereof from the interior area of the support rail 16 after the manufacturing process is complete. Alternatively, an inflatable bladder could potentially be employed as the mandrel. In that instance the bladder would be deflated to permit its removal after the curing of the thermoset resin or the solidification of the thermoplastic resin of the support rail 16 is finished. An autoclave may also be used to help cure the layup and to obtain a more aesthetically pleasing appearance and finish.

In one implementation a majority of the carbon fibers making up the carbon fiber construction of the support rails 16 are preferably orientated parallel along the major longitudinal axis (axis 16a in FIG. 2) of the support rail 16 to provide excellent load bearing characteristics. The carbon fibers may vary considerably in length, but it will be appreciated that the load bearing characteristics of the support rail 16 will be improved if lengths of carbon fiber are used that extend over some definite longitudinal length of the support rail (e.g., at least several inches) rather than carbon fibers that are very short in length (e.g., only a fraction of an inch in length or less). Also, if multiple plys are used, then it may preferred to arrange the plys such that one ply has its carbon fibers extending parallel to the major longitudinal axis (axis 16a in FIG. 2) of the support rail 16 (also expressed as 0 degrees), and then the next ply has its fibers extending normal to the major longitudinal axis 16a (also expressed as 90 degrees), and then potentially the next ply has its fibers extending at an angle between 0-90 degrees, for example at an angle of 45 degrees, relative to the major longitudinal axis 16a. But maximum load bearing strength is achieved with a majority of the carbon fibers oriented parallel to the major longitudinal axis 16a.

The shape and contour of the support rail 16 may be modified considerably, but in the embodiment shown the support rail 16 has a central portion 20 and integrally formed leading and trailing ends 22 and 24 respectively. The leading and trailing ends 22 and 24, respectively, each form a support foot that may function to support the central portion 20 elevationally above an outer body surface 12 of a vehicle when the support rail is secured to the outer body surface. The central portion may include a central support foot 26 which may be formed from different materials, for example aluminum or stainless steel. Each of the leading and trailing ends 22 and 24 may also include a metallic component 28 and/or 30, such as an aluminum or stainless steel plate or bracket, which is fixedly secured to its respective trailing end (22 or 24). Threaded mounting studs 32 may be secured to each of the metallic components 28 and 20, and optionally also to the central support foot 26, so that the support rail 16 can be fixedly secured to the outer body surface 12 of the vehicle 14. The metallic components 28 and/or 30 may be formed in suitable shapes and dimensions to rest in a roof ditch of the outer body surface 12 if desired.

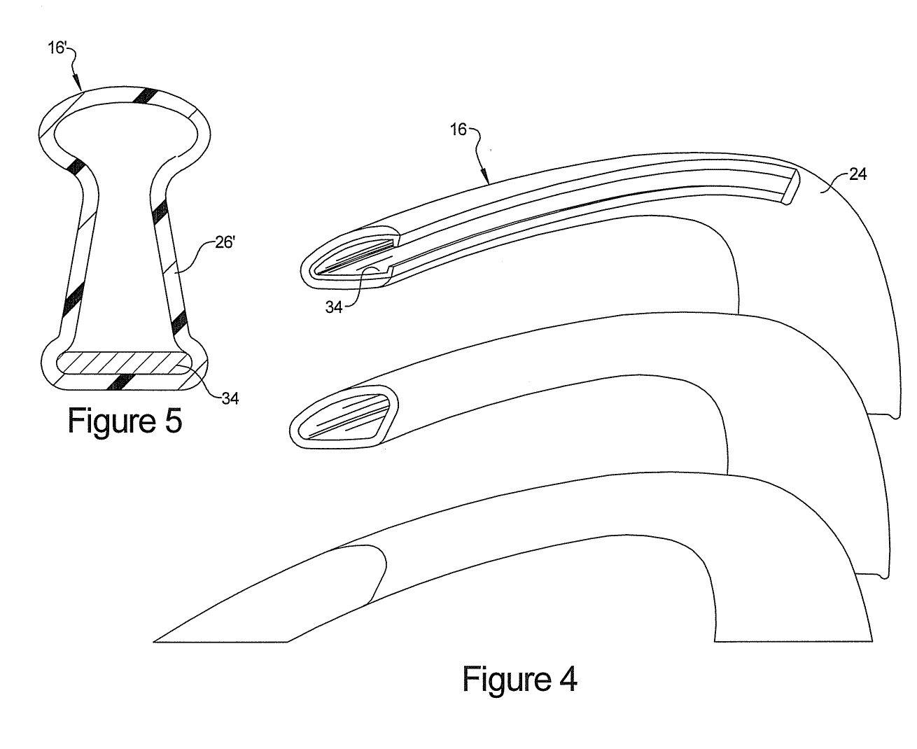

In one implementation a portion of the support rail 16 may be formed in somewhat of a U-shape, as shown in FIG. 4, and a generally U-shaped section of metallic (e.g., aluminum) track 34 may be inserted molded into the support rail 16. Preferably the track 34 opens toward the other one of the support rails 16 when the two support rails are installed on the outer body surface 12 of the vehicle 14. In this manner the tracks 34 open towards each other and can be used to engage with securing (e.g., clamping) structure at the opposing end supports of 18a of each of the cross bars 18. In another implementation the track 34 may extend along the entire length of the central portion 20 to provide even further strength and rigidity to the support rail 16.

In another implementation, the support foot 26 and the metallic components 28 and 30 may all be integrally formed with the central portion 20 and the ends 22 and 24, respectively.

In still another implementation, the support foot 26 may be integrally formed from carbon fiber material with the remainder of the support rail 16, and the metal components 28 and 30 may all be integrally formed with the central portion 20 and the ends 22 and 24. The ends 22 and 24 and the central portion 20 may further include metallic plates or brackets insert molded therein for even further strength at those areas where the support rail 16 will be affixed to the outer body surface 12. For example, FIG. 5 shows an implementation of a support rail 16′ in alternative with an alternative construction where the support foot 26′ is integrally formed with the central portion 20′ and a metallic plate 36 has been insert molded within the support foot 26′.

It will be appreciated that an ultraviolet light protective coating could be applied to the exterior surfaces of the support rail 16. Alternatively the support rails 16 could be painted with a suitable paint.

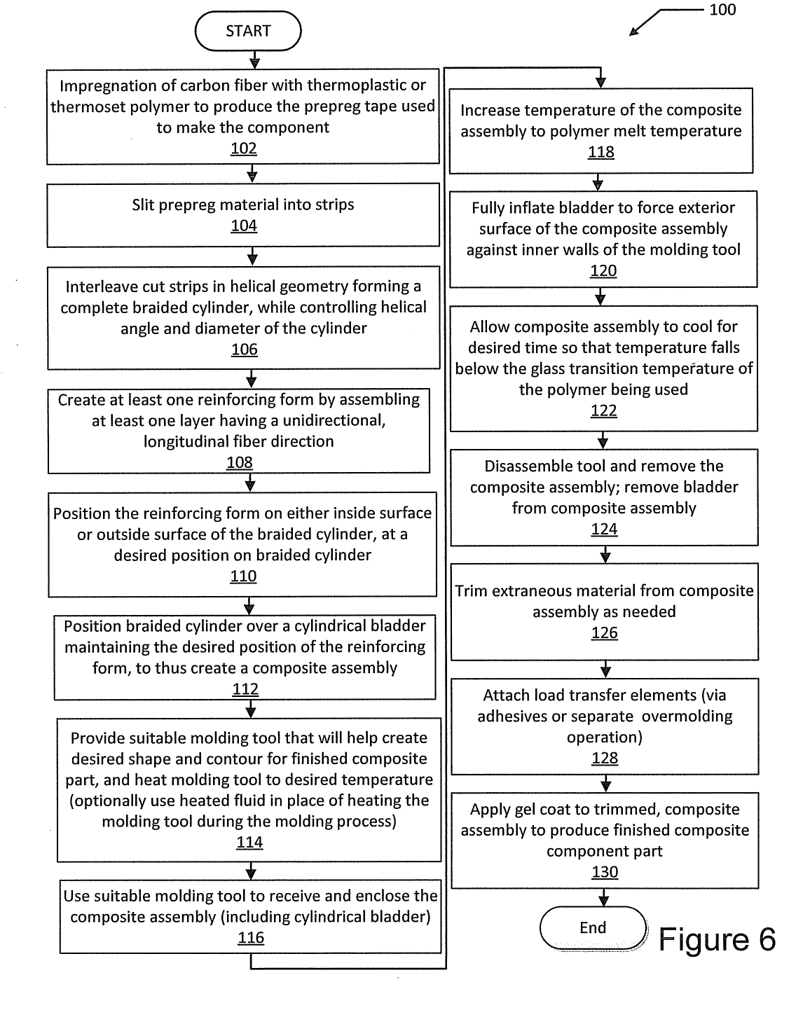

Referring now to FIG. 6, a flow chart 100 is presented to illustrate another example of a sequence of operations that may be performed to produce a unitary, composite support rail. While the following discussion may describe the support rail as being made from carbon fiber, it will be appreciated that any suitable types of fibers may be used, and the reference to “carbon” fiber is merely to describe one specific type of construction which is possible.

It will also be appreciated that the operations explained in connection with FIG. 6 need not be performed in exactly the order in which they are shown in FIG. 6. As such, those of ordinary skill in this art will appreciate that minor variations in the sequence of the operations shown in FIG. 6, as well as the substance of the operations, may be implemented without departing from the scope of the appended claims. The unitary composite part formed from the operations of FIG. 6 may be essentially any article carrier component having at least a portion which is of a tubular construction (e.g., support rail, cross bar, etc.).

Initially at operation 102, carbon fiber that will be used to make the article carrier component is impregnated with thermoplastic or a thermoset polymer to produce a prepreg tape. Either impregnation approach of melt or powder impregnation may be used, and the type of approach used can influence the overall cost of the prepreg tape. Other contributors to cost may be the cost of the carbon fiber, the cost of thermoplastic polymer and cost of the impregnation step. Prepreg tape widths can vary significantly, but typically are from three to forty inches in width.

At operation 104 the prepreg tape may be slit to produce the strips required in a subsequent braiding operation. The cost of slitting is proportional to strip width. Typical strip width is about 0.1 inch and variation in width should be carefully controlled to ensure braidability.

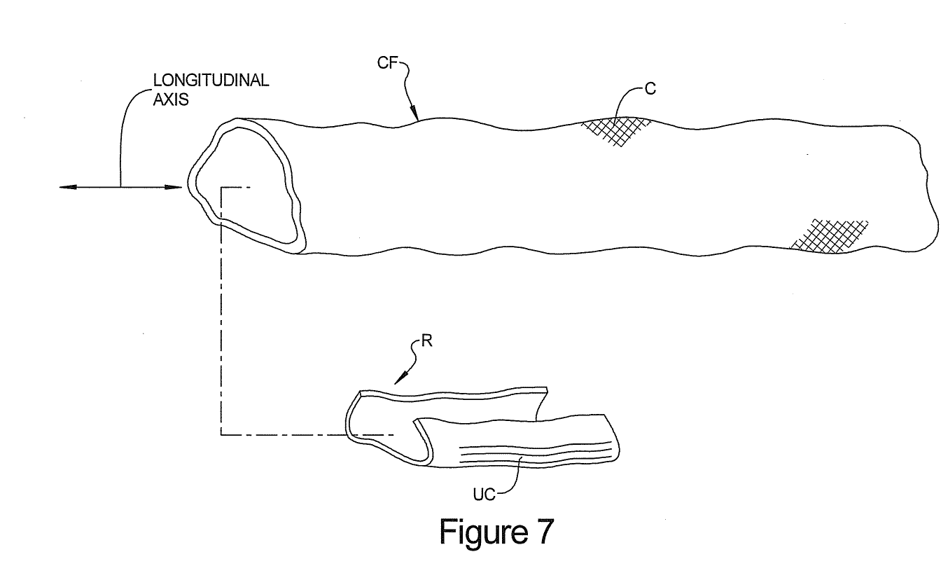

At operation 106 the prepreg strips are braided into a tubular cylindrical form where strips are interleaved using a curvilinear geometry, and in one implementation a helical geometry. Both the helical angle of the fibers and the diameter of the cylindrical form may vary to suit the needs of a specific application. But for the helical angle, preferably a range of between about 0-+/−90 degrees, and more preferably between about +/−20 degrees and +/−75 degrees, relative to a longitudinal axis of the cylindrical form, will be carefully maintained during the braiding process. The cylindrical form may resemble a tubular “sock”, designated by “CF” in FIG. 7, with carbon fibers “C”, and may include sacrificial yarn made from LYCRA® stretchable fibers or any other suitable type of somewhat stretchable fibers or yarn. The outer perimeter of the cylindrical form will preferably be kept carefully within a range of about 2.0 inches to about 9.0 inches but this may will considerably depending on the design and dimensions of the specific article carrier component being manufactured. Manufacturing considerations concerning braiding thermoplastic versus thermoset prepreg should also be considered.

Referring to operation 108, at least one “reinforcing” form or ply may then be created, as also shown in FIG. 7. The reinforcing form may be made up of at least one layer of carbon fibers “UC” all oriented unidirectionally in a longitudinal direction, relative to the longitudinal axis of the article carrier component which is to be manufactured. The fibers may be assembled parallel to one another and stitched together with sacrificial elastomeric yarns such as yarns made from LYCRA® stretchable fibers or any other suitable stretchable fibers. The precise shape of the reinforcing form R and its dimensions, will be dictated in part by the specific shape that is desired for the finished support rail 16, as well as where extra structural strength and reinforcement is desired in the finished support rail 16. More than one reinforcing form R may be used, or alternatively the reinforcing form R may be formed into a tubular “sock”, similar to the cylindrical form CF. Combinations of reinforcing plys and tubular socks could be used together as well. If more than one reinforcing form R is used, the various reinforcing forms R could be constructed so that their carbon fibers extend in different directions relative to one another (i.e., so that they are not parallel). Possibly one reinforcing form R could be constructed which has two or more layers (or plys) of fibers, such as carbon fibers, that do not run perfectly parallel to one another.

At operation 110 the reinforcing form R may be positioned either on the inside or on the outside surface of the braided cylindrical form CF, at a desired position on the form CF. Simply as one example, FIG. 7 indicates that the reinforcing form R is inserted into the interior of the braided cylindrical form CF. Together the cylindrical form CF and the reinforcing form R may be viewed as a composite assembly CA. As with the embodiment shown in FIG. 4, a modified cylindrical form CF could also be constructed to accommodate a metallic track during the molding process, such that the metallic track is essentially molded “within” a portion of the finished composite part, but such that a portion of the track is exposed on the finished composite part to permit attachment of other components to the track.

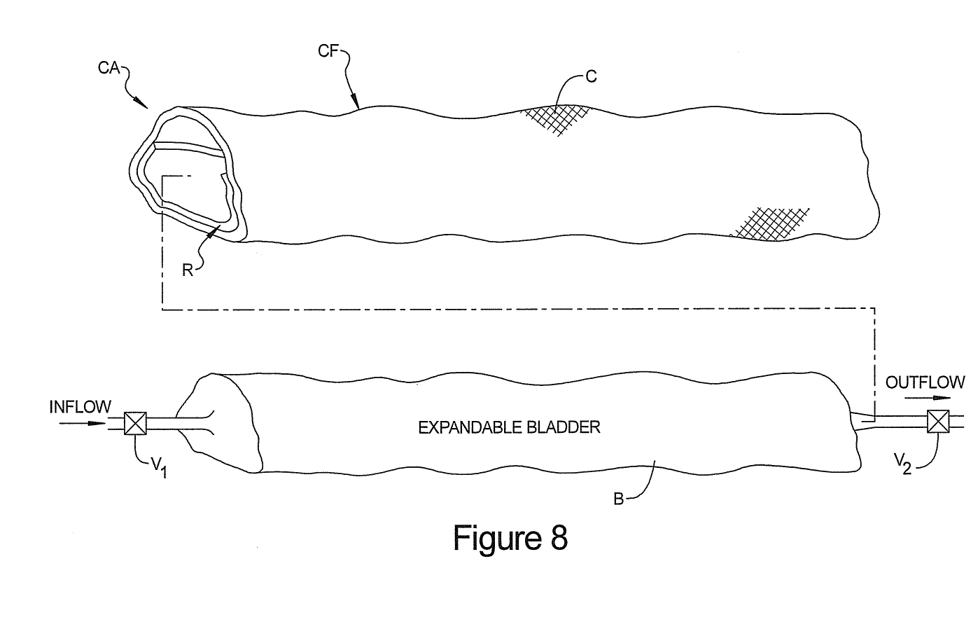

At operation 112 the braided cylindrical form CF may be placed over a cylindrical bladder that is able to be inflated, while maintaining the desired position of the reinforcing form R, to thus create a composite assembly. The cylindrical bladder is shown as component “B” in FIG. 8. The bladder B may be constructed such that when it is fully inflated, it will be able to force all, or substantially all, of the outer surface area of the cylindrical form CF against an interior surface of a molding tool. In this regard it will be appreciated that the bladder B, when fully inflated, may generally follow the desired contour of the finished support rail 16. Alternatively, the bladder may be constructed to form a simple cylinder when fully inflated or substantially fully inflated. The diameter of the braided cylindrical form CF can be increased or decreased by extension or compression of the braid along the longitudinal axis of the cylindrical form CF. Thus, after passing the braided cylindrical form CF over the cylindrical bladder B, the braided cylindrical form CF can be stretched or compressed axially to conform with the bladder B. At this point it will also be appreciated that the bladder B may be deflated or possibly partially inflated. Care should be taken since the curvilinear fiber angle of the carbon fibers C will be influenced by the stretching and compressing actions. In this regard it will also be appreciated that the perimeter of the part, in this example support rail 16, will change along its longitudinal length, which will affect the curvilinear fiber angle differently at different points along the length of the support rail 16. Thus, consideration should be given to the initially selected curvilinear fiber angle to account for changes in this angle during the assembly and molding operations described herein.

The unidirectional longitudinal fibers UC of the reinforcing form R will provide enhanced longitudinal stiffness to the finished article carrier component. While it is anticipated that in most instances it may be preferred to orient the reinforcing form on the inside of the cylindrical form CF, as stated above it is possible to orient the reinforcing form R on the outer surface of the cylindrical form CF as well, but care should be taken to maintain its precise position when handling the assembly CA during its placement over the bladder B and in a molding tool.

At operation 114, a suitable molding tool is provided that includes a cavity (when the tool is closed) that is shaped in accordance with the desired shape and contour that the finished composite assembly CA part is to have. The molding tool may be heated or cooled to a desired temperature. Optionally, a heated fluid, a gas or steam may be used to pressurize the bladder. Whichever means is selected, the heat produced should be sufficient to carry out a thermoset reaction or thermoplastic melting, or in other words sufficient to heat the resin being used to form the composite part. If the molding tool is heated, then prior to insertion of the composite assembly CA into the tool, its temperature may be increased to the molding level through radiant or inductive heat transfer methods. Overall cycle manufacturing time for making a plurality of the composite article carrier components may be significantly influenced by the heating cycle time.

At operation 116 the molding tool is used to receive the composite assembly CA (i.e., the braided cylinder with the bladder inserted therein). The bladder B may be partially inflated at this point. The molding tool may be designed so that it may be opened (or disassembled) so that the molded composite assembly CA can be easily removed. The desired shape and contour of the molded composite assembly CA is imparted to it as the bladder is inflated and the cylindrical form CF and reinforcing layer R are forced against the interior surfaces of the cavity of the molding tool.

At operation 118, after reassembling the tool around the composite assembly CA, the temperature of the composite assembly is increased to the polymer liquid state and the bladder B is fully inflated. The temperature of the molding tool may be raised to a suitable temperature for the specific materials being used in the cylindrical form CF and the reinforcing form R, but typically the molding temperature will not exceed about 600 degrees Fahrenheit. At operation 120 the inflatable bladder B is fully pressurized to forcibly press the exterior surface of the composite assembly CA against the inner wall surfaces of the cavity within the molding tool. This serves to force the composite assembly CA to assume the geometric shape of the mold cavity.

At operation 122, the composite assembly CA is then cooled to a predetermined desired time. This allows the temperature of the composite assembly CA to fall to below the glass transition temperature of the polymer that is used in the composite assembly CA. Alternatively, cooling of the composite assembly CA may be accomplished by passing a suitable cooling medium through the bladder and controlling an exchange of the medium through valves V1 and V2 and a suitable control system (not shown).

At operation 124 the tool is disassembled and the molded composite assembly CA is removed from the molding tool. The bladder B is deflated and is then removed from the molded composite assembly CA. At operation 126 extraneous material is trimmed from the molded composite assembly CA wherever required.

At operation 128, one or more load transfer elements may be attached to the trimmed, molded composite assembly CA. This can be accomplished by adhesive attachment to existing fittings or by injection molding of fittings through well known over-molding techniques on the trimmed, molded composite assembly. At operation 130 a gel coat may be applied to the trimmed, molded composite assembly CA to produce a finished composite component part that is ready to be installed on a vehicle. In this example the finished composite component part is support rail 16 shown in FIG. 1. Preferably the gel coat will also incorporate a suitable ultraviolet light (UV) resistant additive to aid in helping to prevent and/or reduce changes to the color of the finished composite component part that would otherwise be experienced from continued exposure to UV rays.

It will also be appreciated that while the above embodiments have been described as being constructed with carbon fibers, that other types of fibers, such as glass fibers, or KEVLAR® fibers, or any other suitable fibers, could be used in place of carbon fibers. Also, it is not necessary that the cylindrical form CF include the same type of fibers as the reinforcing form R; different types of fibers could be selected to impart different constructional/strength characteristics to the finished composite part.

It will also be appreciated that at least a portion of a cross bar of a vehicle article carrier system could also be formed through the construction techniques described herein with little or no modification to the described manufacturing operations.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A method of manufacturing a vehicle article carrier component, comprising:
forming a braided, tubular cylindrical form including a plurality of fibers having a helical pattern;
providing a reinforcing form of unidirectionally oriented fibers that is positioned at a predetermined location on the braided tubular cylindrical form to create a composite assembly, on one of an interior surface or an exterior surface of the braided tubular cylindrical form;
providing a resin for saturating the composite assembly;
inserting an inflatable bladder within the composite assembly without upsetting positioning of the reinforcing form;
positioning the composite assembly in a cavity of a molding tool, wherein the cavity is shaped and of dimensions to create the vehicle article carrier component;
inflating the inflatable bladder to force an outer surface portion of the composite assembly against interior surfaces of the molding tool;
heating at least one of the molding tool, or a pressurizing fluid or a gas, in the bladder to cause the composite assembly to be heated to a temperature sufficient to cause the resin to flow and fully saturate the fibers of the braided, tubular cylindrical form and the fibers of the reinforcing form;
waiting a predetermined time for the composite assembly to cool; and
removing the composite assembly from the molding tool, wherein the composite assembly has been shaped to form the vehicle article carrier component.

2. The method of claim 1, wherein providing a reinforcing form comprises providing a reinforcing form comprised of unidirectional carbon fibers.

3. The method of claim 1, wherein the resin is impregnated into the braided, tubular cylindrical form to form a prepreg assembly.

4. The method of claim 1, wherein the resin is infused into the composite assembly through an opening in the molding tool while the composite assembly is being heated.

5. The method of claim 1, wherein the reinforcing form is inserted inside the braided, tubular cylindrical form at the predetermined location.

6. The method of claim 1, wherein the reinforcing form is placed over an outer surface portion of the braided, tubular cylindrical form at the predetermined location.

7. The method of claim 1, further comprising trimming excess material from the composite assembly after the composite assembly is removed from the molding tool.

8. The method of claim 1, further comprising applying a gel coat to the composite assembly.

9. The method of claim 1, further comprising securing at least one article securing component to the vehicle article carrier component through one of:
an adhesive; or
a subsequent overmolding operation in which the article securing component is non-removably attached to the vehicle article carrier component.

10. A method of manufacturing a vehicle article carrier component, comprising:
forming a braided, tubular cylindrical form impregnated with a resin, the braided, tubular cylindrical form including a plurality of fibers having a helical pattern, the helical pattern including having the fibers extending at an angle of about 0 degrees to about +/−90 degrees relative to a longitudinal axis of the braided, tubular cylindrical form;
providing a reinforcing form, impregnated with a resin, of unidirectionally oriented fibers that is positioned at a predetermined location on an inside surface of the braided tubular cylindrical form, to create a composite assembly;
inserting an inflatable bladder within the composite assembly without upsetting positioning of the reinforcing form;
positioning the composite assembly in a cavity of a molding tool, wherein the cavity is shaped and of dimensions to create the vehicle article carrier component;
inflating the inflatable bladder to force an outer surface portion of the composite assembly against interior surfaces of the cavity of the molding tool;
heating at least one of the molding tool or the pressurizing fluid in the bladder to cause the composite assembly to be heated to a temperature sufficient to cause the resin to flow and fully saturate the fibers of the braided, tubular cylindrical form and the fibers of the reinforcing form;
waiting a predetermined time for the composite assembly to cool; and
removing the composite assembly from the molding tool, wherein the composite assembly has been shaped to form the vehicle article carrier component.

11. The method of claim 10, wherein the mold is heated to a temperature of no more than about 600 degrees Fahrenheit.

12. The method of claim 10, further comprising trimming extraneous material from the composite assembly after the composite assembly is removed from the molding tool.

13. The method of claim 10, further comprising applying a UV resistant gel coat to the composite assembly after the composite assembly has been removed from the molding tool.

14. The method of claim 10, further comprising securing a vehicle article securing component to the composite assembly after the composite assembly has been removed from the mold.

15. The method of claim 10, wherein the composite assembly is stretched longitudinally after the inflatable bladder is inserted therein, to bring the composite assembly into contact with the bladder.

16. A molded, unitary vehicle article carrier component comprising:
a tubular central portion;
a curving leading edge and a curving trailing edge each forming a support foot for positioning the central portion elevationally above an outer roof surface of a vehicle when the unitary vehicle article carrier component is secured to the outer roof surface; and
the tubular central portion and the curving leading edge and curving trailing edge portion being integrally formed in a molding process from a braided, tubular cylindrical form including a plurality of fibers and a polymer resin.

17. The molded, unitary vehicle article carrier component of claim 16, further including a reinforcing form of unidirectionally oriented fibers that is positioned at a predetermined location on the braided tubular cylindrical form prior to the molding process being executed.

18. The molded, unitary vehicle article carrier component of claim 16, further comprising a central support portion configured to be secured to the tubular central portion after the molding process is executed, and also attached to the outer roof surface, to assist in supporting the tubular central portion fixedly relative to the outer roof surface.

19. The molded, unitary vehicle article carrier component of claim 16, further comprising an ultraviolet light resistant gel coating applied to the central support portion and the leading edge and trailing edge portions after the molding process is performed.

20. The molded, unitary vehicle article carrier component of claim 16, wherein the fibers of the tubular central portion extend in one of a curvilinear pattern or a helical pattern.
